(19) United States
(12) Patent Application Publication
(10) Pub. No.: US 2009/0030985 A1
(43) Pub. Date: Jan. 29, 2009

(54) FAMILY-BASED ONLINE SOCIAL NETWORKING

(76) Inventor: Zheng Yuan, San Jose, CA (US)

Correspondence Address: CESARI AND MCKENNA, LLP, 88 BLACK FALCON AVENUE, BOSTON, MA, 02210, US

(21) Appl. No.: 12/179,097

(22) Filed: Jul. 24, 2008

Related U.S. Application Data
(60) Provisional application No. 60/962,014, filed on Jul. 24, 2007.

(51) Int. Cl. G06F 15/16

(52) U.S. Cl. 709/204

(57) ABSTRACT

According to embodiments of the disclosure, social networking families are established in an online social network. Each family has family members, a family profile, and a family policy, where the family profile provides information about the family to members of the social network, and the family policy defines the accessibility of information about the family within the social network. Different families may be associated as “family friends,” such that each member of one family may access the family profile of another family provided that the families are family friends.

### RELATED APPLICATIONS

This application claims priority to U.S. Provisional Patent Application Ser. No. 60/962,014, entitled SYSTEM AND METHOD FOR FAMILY-BASED SOCIAL NETWORKING filed Jul. 24, 2007 by Zheng Yuan, the disclosure of which is incorporated herein in its entirety by reference.

### TECHNICAL FIELD

The present disclosure relates generally to computer networks, and, more particularly, to online social networking.

### BACKGROUND

Social networking, such as establishing professional or personal affiliations (e.g., friendships), may be supported by an online social network. In general, online social networks comprise social network members (e.g., individual network users) that typically have a member profile that a corresponding member/user controls to convey information about the member. For instance, this profile may be accessed or “viewed” through an associated application, such as a web browser on the Internet accessing web pages from one or more social networking web servers. These member profiles may be interrelated through associations (friendships), such that a specific member's profile may be accessible to other members of the network (e.g., the member's friends) based on policies in place on the profile and any related associations.

Notably, members of a social network may establish an affiliation with one or more specific groups (i.e., sub-networks of members within the social network), which may have a separate group profile to convey information about the group (e.g., what the group is, who its members are, etc.). In particular, in addition to sharing affiliation in the group (e.g., sharing similar interests, businesses, organizations, etc.), members of a group may access the profiles of other members of that same group based on group policies. Typically, affiliation with a particular group occurs on an individual member basis; that is, to be affiliated with a group, each member must individually seek such affiliation. Currently, online social networking groups go no further than member affiliation within groups, group profiles to provide information about the group, and a listing of the group's members.

### BRIEF DESCRIPTION OF THE DRAWINGS

The embodiments described herein may be better understood by referring to the following description in conjunction with the accompanying drawings in which like reference numerals indicate identically or functionally similar elements, of which:

FIG. 1 illustrates a computer network;

FIG. 2 illustrates an example client device;

FIG. 3 illustrates an example server;

FIG. 4 illustrates an example database of profiles and policies;

FIG. 5 illustrates an example of online family-based networking logic;

FIG. 6 illustrates an example procedure for establishment of social networking families; and

FIG. 7 illustrates an example procedure for managing access to profiles in a family-based online social network.

### DESCRIPTION OF EXAMPLE EMBODIMENTS

### Overview

According to embodiments of the disclosure, social networking families are established in an online social network. Each family has family members, a family profile, and a family policy, where the family profile provides information about the family to members of the social network, and the family policy defines the accessibility of information about the family within the social network. Different families may be associated as “family friends,” such that each member of one family may access the family profile of another family provided that the families are family friends. Also, according to embodiments herein, other family-friend-based policies may be defined to manage access rights to family member profiles (personal or family-based), as well as allowing individual users to be friends of a family without being family members.

### Description

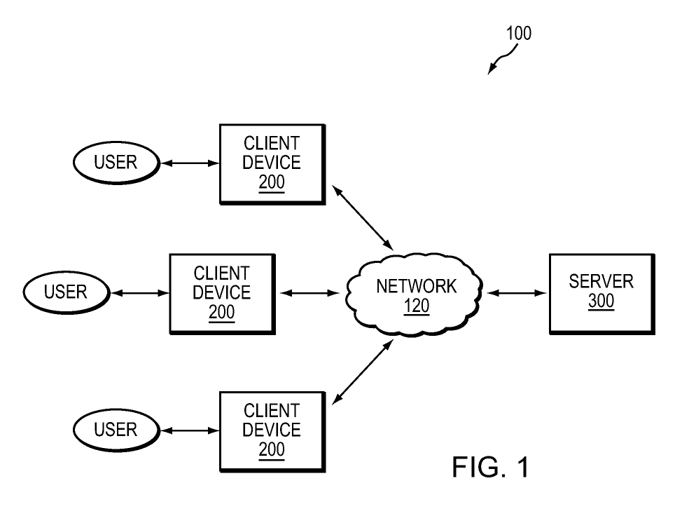

FIG. 1 is a schematic block diagram of an example computer network 100 illustratively comprising nodes/devices, such as one or more client devices 200 (e.g., a computing platform configured to act as a client device, such as a computer, a personal digital assistant, etc.) and at least one server 300 interconnected by links/network 120 as shown and as described further herein. Those skilled in the art will understand that any number of nodes, devices, links, etc. may be used in the computer network, and that the view 20 shown herein is for simplicity. Also, as used herein, the term “node” may be used to generally describe a node, device, computer, etc., as may be appreciated by those skilled in the art.

Network 120 may comprise or be supported by one or more suitable communication networks, such as, for example, a telecommunications network that allows communication via one or more telecommunications lines/channels. In particular, the communication or data networks, such as the Internet, may be used to deliver content, such as for the collaborative computing sessions herein. The Internet is an interconnection of computer clients and servers located throughout the world and exchanging information according to Transmission Control Protocol/Internet Protocol (TCP/IP), Internetwork Packet eXchange/Sequence Packet eXchange (IPX/SPX), AppleTalk, or other suitable protocol. The Internet supports the distributed application known as the “World Wide Web.” In particular, web servers maintain websites, each comprising one or more web pages at which information is made available for viewing and audio/hearing. Each website or web page may be supported by documents formatted in any suitable conventional markup language (e.g., HTML or XML). Information may be communicated from a web server to a client using a suitable protocol, such as, for example, Hypertext Transfer Protocol (HTTP) or File Transfer Protocol (FTP).

Notably, users (e.g., social network members, as described herein) may operate and otherwise interface with a client device 200. Each client device 200 may comprise an electronic device with capability for visual and/or auditory presentation. Thus, a client device 200 can be, for example, a desktop personal computer (PC), a laptop computer, a workstation, a personal digital assistant (PDA), a wireless telephone, a smart phone, an Internet television, and the like. Each client device 200 supports communication by a respective user, in the form of suitable input device (e.g., keyboard, mouse, stylus, keypad, etc.) and output device (e.g., monitor, display, speech, voice, or other device supporting the presentation of audible/visual information). Further, each client device 200 may be interconnected with a suitable communications network 120 such as, for example, the Internet, and may appear as a client computer thereon.

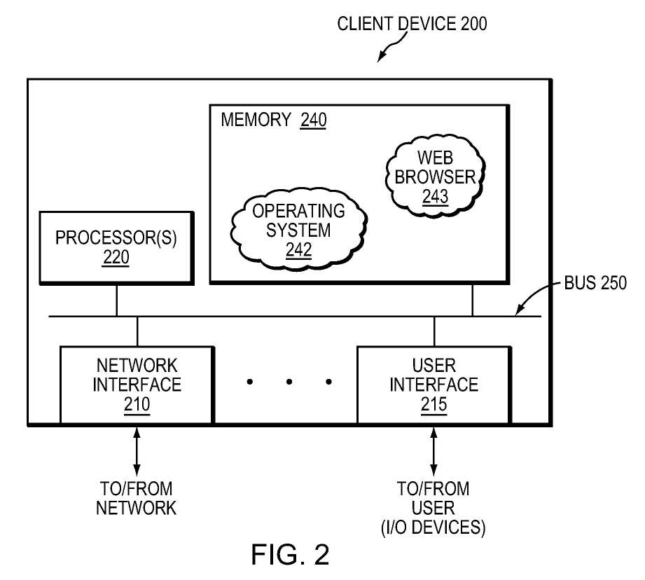

For instance, FIG. 2 illustrates a schematic block diagram of an example client device 200 that may be advantageously used with one or more embodiments described herein, e.g., for family-based online social networking. In particular, the device 200 comprises a plurality of network interfaces 210, one or more user interfaces 215, one or more processors 220, and a memory 240, each interconnected by a system bus 250. The user interfaces 215 contain the mechanical, electrical, and signaling circuitry to communicate with one or more user input and output devices, such as keyboards, keypads, mice, monitors, etc., as will be understood by those skilled in the art. Also, the network interfaces 210 contain the mechanical, electrical, and signaling circuitry for communicating data over physical/wireless links coupled to the network 120. The network interfaces 210 may be configured to transmit and/or receive data using a variety of different communication protocols suitable for the network. For example, the network interfaces, as described herein, may be adapted to communicate traffic (data/packets) over communication channels (e.g., the Internet) for use with online social networking applications.

The memory 240 comprises a plurality of storage locations that are addressable by the processor(s) 220 and the network interfaces 210 for storing software programs and data structures associated with the embodiments described herein. The processor(s) 220 may comprise necessary elements or logic adapted to execute the software programs and manipulate the data structures. An operating system 242, portions of which are typically resident in memory 240 and executed by the processor(s), functionally organizes the device by, inter alia, invoking operations in support of software processes and/or services executing on the device. For example, in one embodiment, each client device 200 may operate under the control of a suitable operating system (OS) (e.g., WINDOWS, UNIX, etc.) to run software applications (e.g., in the form of code modules) which may be installed, received, or downloaded. At least some of these software applications may support specific functions, such as, for example, functions that allow convenient access and navigation of the Internet (e.g., the World Wide Web). In particular, software processes and/or services (e.g., applications) that may be executed on the device may comprise a web browser application/process 243 and other applications (not shown). It will be apparent to those skilled in the art that other types of processors and memory, including various computer-readable media, may be used to store and execute program instructions pertaining to the inventive technique described herein.

Web browser process 243 may contain computer executable instructions executed by each processor 220 to generally perform functions to manage or control various processes or aspects during the course of an online activity (e.g., social networking) in which a participant (user) may browse web pages on the Internet (e.g., the World Wide Web) and/or interact with other users. For instance, web pages may be generated by one or more web servers providing content for the web pages and managing the operation of the client interaction with the web pages. In other words, web browser 243, as will be understood by those skilled in the art, provides a graphical user interface (GUI) to web pages/sites though the user interfaces 215 at client device 200, accordingly.

As noted, the client devices 200 interact with a server 300 over a network 120. The server 300 may be a computer system that is connected to network 120, and which may comprise and appear as one or more server computers thereon. Server 300 may store information (e.g., content) and application modules which can be provided to the client devices 200. In some embodiments, these application modules are downloadable to the client devices 200 and may support various functions. Illustratively, the client devices 200 and the server 300 may interact in a client/server architecture, which may provide high performance and security for the online social networks described herein.

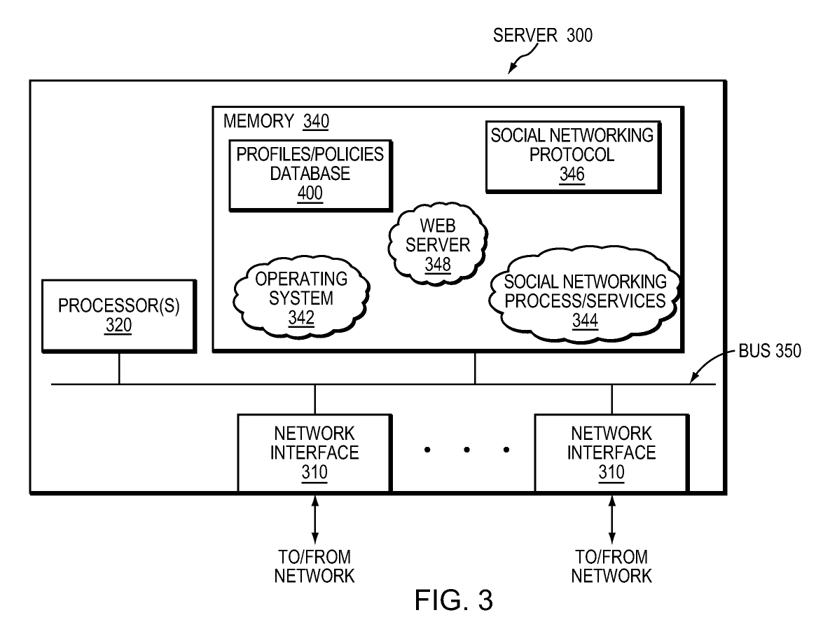

FIG. 3 illustrates a schematic block diagram of an example server device 300 that may be advantageously used with one or more embodiments described herein, e.g., for family-based online social networking. In particular, server device 300 comprises a plurality of network interfaces 310, one or more processors 320, and a memory 340, each interconnected by a system bus 350, as described above. (Notably, while an illustrative embodiment described herein shows a single server, a collection of servers may also operate to perform the functions described herein. For example, each of a plurality of servers may be configured to perform a respective process/function. Thus, server 300 may comprise, either as a single server or as a collection of servers, one or more memories, one or more processors, one or more network interfaces (e.g., adapted to communicate traffic for online social networking), etc., as may be appreciated by those skilled in the art.

The memory 340 comprises a plurality of storage locations that are addressable by the processor(s) 320 and the network interfaces 310 for storing software programs and data structures associated with the embodiments described herein. The processor(s) 320 may comprise necessary elements or logic adapted to execute the software programs and manipulate the data structures, such as social network protocol 346 and profiles/policies database 400, as described herein. An operating system 342, portions of which are typically resident in memory 340 and executed by the processor(s), functionally organizes the server by, inter alia, invoking operations in support of software processes and/or services executing on the server. In particular, these software processes and/or services may comprise a web server application/process 348 and a social network application process 344, each as described herein.

Web server process 348 may contain computer executable instructions executed by each processor 320 to generally perform functions related to servicing one or more websites (comprising one or more web pages) or web-based applications, such as in accordance with an online social network as described herein. For example, the web server 348 may store all data (not shown in memory 340) required to operate and manage a family-based online social network. As noted above, information may be communicated from a web server to a client, for example a client web browser 243 using a suitable protocol, such as, e.g., HTTP, FTP, etc.

In one embodiment, the social networking process/services 344 executes on the server 300 according to a social network protocol 346 and accesses a profile and policy database 400 to provide family-based online social networking. An “online social network” is a platform (typically a website, e.g., serviced in conjunction with web server 348) where individuals (users) may connect with other individuals sharing personal or professional interests, place of origin, education at a particular school, etc. Social networking is the practice of expanding and/or maintaining those relationships/connections (e.g., though a social networking site). A variety of services are provided by social networking sites which allow users to communicate and exchange information including, for example, blogging, instant messaging, e-mail messaging, message boards, photo sharing services, etc. Social networking sites such as Facebook™, MySpace®, LinkedIn®, and Yahoo!® (Local have become popular sites for online social networking.

Online social networking sites generally allow users to create personal profiles, thus establishing “member profiles” (e.g., personal web pages) that may be maintained by servers 300. For example, a user may enter personal information, upload a personal picture to his/her member profile, and become “friends” with other users. For instance, users may add blogs, pictures, videos, instant messaging, a list of “friends,” e-mail, bulletin boards, calendars, etc. to their member profiles, which are stored and maintained by the social network's server 300 (e.g., in a database 400, described below). In addition, social networks typically include privacy controls or “policies” that allow a user to choose who can view their profile or contact them. In most social networking services, both users must confirm that they are “friends” before they are linked (“associated”) via the online social network. For example, if User A lists User B as a friend, then User B would have to approve User A's friend request before they are linked as friends. Some social networking sites also include a “favorites” feature that removes the requirement of prior approval from the other user.

To use the social networking services, a user typically logs into the service's website (e.g., MySpace.com) from his or her personal computer (e.g., client device 200). (Note that mobile devices also currently provide access to social networking sites through a web browser or a wireless application protocol (WAP).) Once logged in, a user (corresponding to a member profile) may attempt to access personal web pages of other member's profiles to view those corresponding user's blogs, pictures, videos, etc. Based on various policies established by the member profiles (e.g., private or public profiles), for instance, as interpreted by social networking process/services 344 according to social network protocol 346, web server 348 may or may not therefore display the requested personal web pages (member profiles), accordingly. For example, if User A attempts to view User B's “private” profile and User A and User B are not friends, then User A will be unable to view (i.e., will be denied access to) User B's personal web pages. On the other hand, should User A be friends with User B, User A should be able to access (unless otherwise prevented from accessing) User B's private profile.

As noted above, members of online social networks are often affiliated with one or more social network groups. Social network groups are an efficient manner in which a social network member may maintain connections/relationships with other social network members having similar characteristics. In particular, these social network groups may have a separate group profile (web page) to convey information about the group (e.g., what the group is, who its members are, etc.). Typically, members of a group may access the profiles of other members of that same group based on group policies.

Affiliation with a particular group occurs on an individual member basis; that is, to be affiliated with a group, each member must individually join a group (e.g., subject to approval from a group administrator). Currently, online social networking groups go no further than member affiliation within groups, group profiles to provide information about the group, and a listing of the group's members. However, according to one or more embodiments described herein, techniques are provided that allow groups or “families” to be friends with other groups (families), in a manner that introduces many useful features to online social networking. For instance, it may be desirable for members of a group to each be able to establish/maintain connections with members of other groups without the hassle of individually associating all the members of one group with those members in the other group and visa versa. These and other advantages may be realized according to the various techniques and features described herein for family-based online social networking.

Family-Based Online Social Networking

According to embodiments described herein, social networking families (e.g., groups) are established in an online social network. Each family has family members, a family profile, and a family policy, where the family profile provides information about the family to members of the social network, and the family policy defines the accessibility of information about the family within the social network. Families may be associated as “family friends,” such that each member of one family may access the family profile of another family provided that the families are family friends. Also, according to embodiments herein, other family-friend based policies may be defined to manage access rights to family member profiles (personal or family-based), as well as allowing individual users to be friends of a family without being family members.

Illustratively, certain techniques described herein may be performed by server 300, such as through execution of a social networking process/service 344 in conjunction with web server 348. In particular, the social networking process/service 344 may be configured to operate in accordance with a social network protocol 346, which applies one or more policies to one or more profiles according to a profile/policy database 400. Further, other techniques may be performed by respective components of client devices 200 and server 300 as described herein. For instance, access to manage (create, change, update, etc.) such profiles and policies may be originated by a user (e.g., member) at a client device 200, such as through web browser 243, as may be appreciated by those skilled in the art.

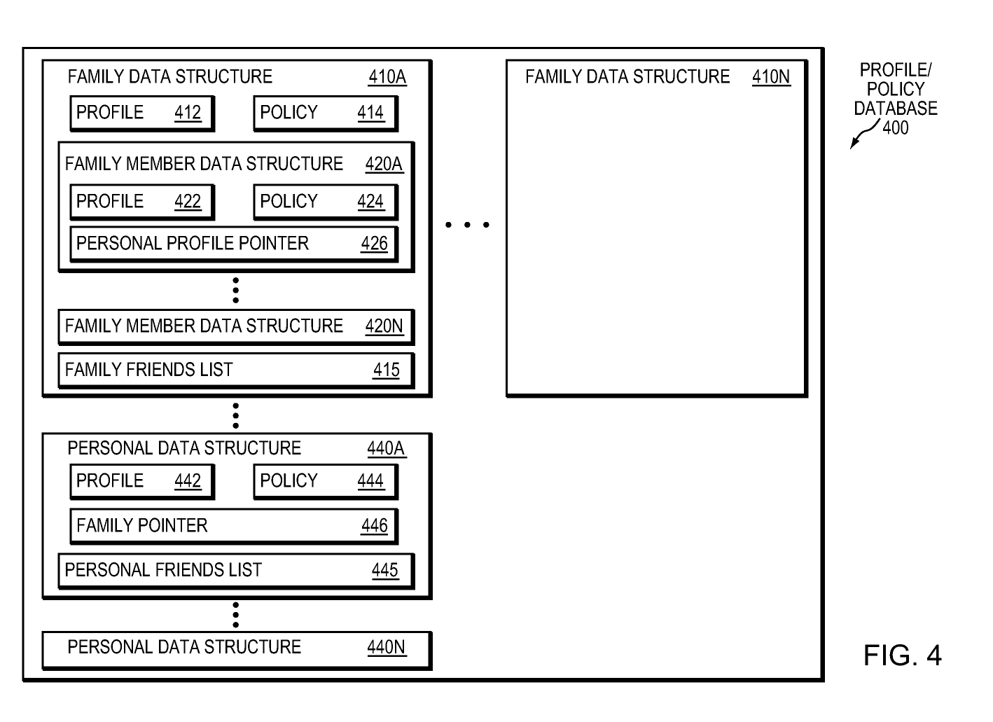

Operationally, the online social networking server(s) 300 are configured to store the profiles and policies associated with a family-based online social network as described herein. For instance, FIG. 4 illustrates an example database 400 of profiles and policies stored on server 300 (e.g., in memory 340), the database illustratively managed and maintained by social networking process/services 344 based on input received from web server 348. (Notably, while a database 400 having data structures is shown, those skilled in the art will appreciate that lists, tables, mappings, etc., may be used in other manners, and such alternatives are within the scope of the techniques described herein as the data structures are merely a representative example.)

According to one or more embodiments, the database 400 comprises a plurality of family data structures 410 (e.g., 410A through 410N) in addition to a plurality member's personal profile data structures 440 (e.g., 440A through 440N). (Those skilled in the art will appreciate that “N” denotes an arbitrary number of data structures, and does not infer an equal number of family and member's personal profile data structures). Specifically, these data structures may be illustratively interpreted by social networking process/services 344, and made available/accessible, e.g., over the Internet, via web server process 348 based on policies contained within the data structures, as described herein.

In particular, each family data structure 410 may further comprise sub-structures, such as a family profile 412, a family policy 414, and a family friends list 415. Illustratively, a family profile 412 may comprise information about a family, such as, e.g., the family's surname, interests of the family, the family's geographic origin, etc. Also, the family profile 412 may comprise information about one or more members of the family (“family members”). For instance, family members may be simply denoted as a list with profile 412, or may each have a dedicated family member data structures 420 (e.g., for family members 420A through 420N). The family policy 414 may define access rights to information of the family profile. For example, as described herein, the access rights may be defined to limit access to certain information of a family profile, such as the geographic location of the family, the ages of family members, etc., while allowing access to other information. Further, family friends list 415 may comprise a list (mapping) of friends of the particular family (e.g., other families or personal members) as described herein.

Notably, the family member data structures 420 may further comprise family member profiles 422 and family member policies 424. That is, the family member profiles 422 may contain information relating to a corresponding member of the family 410 (e.g., 410A). This information may include, for example, interests of the family member, the geographic location of the family member, news or events relating to the family member and the family, etc. Also, the family member policies 424 may define access rights to the information specific for that family member (as described below). For instance, according to one more embodiments described herein, the family member policies 424 may restrict access to information relating to a family member even if the family policy 414 may not restrict access to the information.

According to an aspect of one or more embodiments herein, family member data structures 420 may also have a personal profile pointer 426 which points (maps) to a corresponding member's personal data structure 440 (e.g., 440A-N). A personal data structure 440 may comprise a family member's personal profile 442 and personal policy 444. In particular, each social network user may have one or more of a personal profile 442, a personal policy 444, personal friends 445, and/or a family pointer 446. For instance, a personal profile 442 may be a separate profile from a family members “family profile” 422, and may comprise information about a social network user/member, such as pictures, personal blogs, a personal description, personal contact information, family affiliations, personal friend affiliations, employment/educational information, etc.

Also, a social network user may have one or more personal friends 445, as well as having one or more family friends 415 (e.g., where the user belongs to a first family, which may be friends with a second family). For example, the first social network user may be friends directly with the second family and/or one or more individual members of the second family. Moreover, the first social network user may also be personal friends with a second social network user that may or may not be a member of either the first or second family (or any family). Whether or not the first social network user may be affiliated (friends) with either the second family or the second social network user may be determined by one or more policies (e.g., personal policy, family member policy, family policy, etc.), as well as friendship association techniques described herein and as may be appreciated by those skilled in the art.

Illustratively, a family member's personal profile 442 may or may not be accessible to other family members (e.g., 420N) according to a member's personal policy 444. In one embodiment, a family member's personal policy 444 may also define (e.g., allow, limit, restrict, etc.) access rights to a family member personal profile for, e.g., family friends, members of family friends, social network users, etc. In other embodiments, and as further described herein, a family member's personal policy may hierarchically define (e.g., limit) access rights to information (e.g., personal, family, etc.) otherwise defined (e.g., not limited) by one or more other policies (e.g., family member policy, family policy, etc.) Notably, a social network may have one or more intrinsic policies (e.g., policies of social network protocol 346) which may hierarchically define (e.g., limit) access rights to information (e.g., family, personal, etc.) otherwise defined (e.g., not limited) by one or more other policies (e.g., personal policy, family member policy, family policy, etc.). For instance, one simple example of a social network intrinsic policy may limit access to profane or indecent material provided in one or more social network user profiles (e.g., personal, family member, family, etc.).

According to one or more embodiments herein, a member's personal profile 442 and a family member profile 422 may each point (map) to each other by, e.g., family pointer 446 or personal profile pointer 426. Notably, according to one or more other embodiments described herein, a personal profile 442 may simply be a family member profile 422 (e.g., the personal profile may include information relating to a family or family membership or the family member profile may include personal information relating to the social network user). Alternatively, a family member profile 422 may be a limited version of a member personal profile 442. For instance, content of the member personal profile 442 may be limited, such as by showing content according to one or more policies (e.g., personal policy, family member policy, family policy, etc.) based on whether an outside user is viewing the family profile or directly viewing the personal profile (and based on access rights therein) Note further that a social network user may have one profile (e.g., a family member profile or a personal profile) or a plurality of profiles (e.g., a personal profile, a family member profile, etc.).

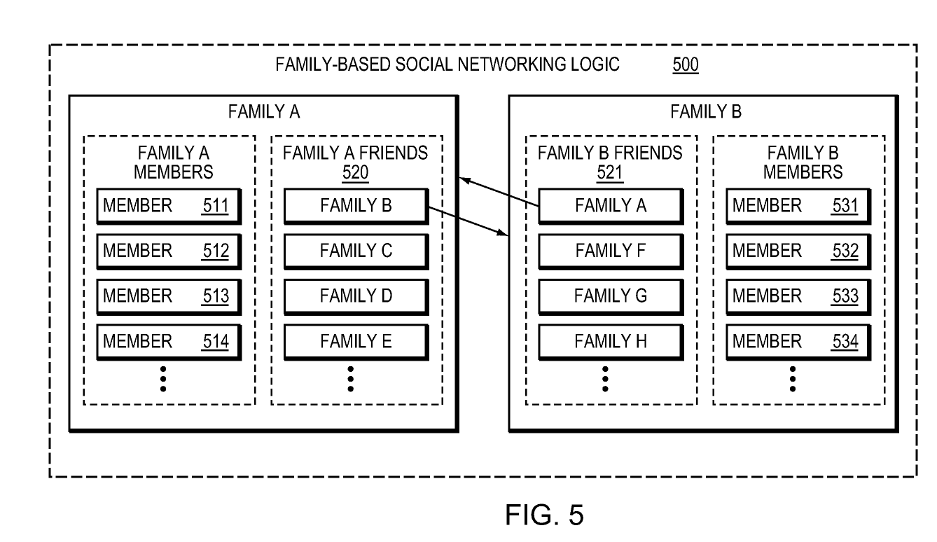

FIG. 5 illustrates an example of online family-based networking logic 500 for implementing a family-based social network according to one or more embodiments described herein. Two families are illustrated—Family A and Family B—each comprised of a plurality of family members 511-514 and 531-534, respectively, where each family member represents a user of the social networking system as described above. Also, each family also includes a listing of family “friends.” In the illustrated example, Family A's friends 520 include Families B, C, D, and E and Family B's friends 521 include Families A, F, G and H. Thus, as illustrated, Family A and Family B are linked together (associated) inasmuch as each family is a “friend” of the other. Consequently, Family A may be permitted to access Family B's profile and other related social networking data and services, and vice-versa.

As noted above with reference to FIG. 4, each member 511-514, 531-532 may have a family-based social networking profile 422 and policy 424. The family member profile 422 may include various types of information related to the member such as blurbs (e.g., “About Me,” “Who I'd like to meet”), interests, blogs, personal images, and hyperlinks to allow other users to communicate with the member (e.g., via instant messaging, e-mail, etc). Various different and/or additional types of information may be contained within the member's profile consistent with the underlying principles of the embodiments described herein. For instance, a link 426 to a personal profile 442 may be included within the profile 422, such as where the family member profile 422 and member personal profile 442 differ as described above. (Notably, for convenience, use of “family member profile” and “family member policies” implies either a family member profile/policy 422/424 or a family member personal profile/policy 442/444, depending upon the configuration of the social network as described above, unless otherwise specifically noted.)

In one or more embodiments, the member policy 424 specifies the personal information of profile 422 which may be accessed by other users. The policy 424 is configurable by each individual family member 511. For example, family member 511 may specify via the policy 424 that any other users within Family A (i.e., the member's family) can access all of the member's 511's personal information whereas users outside of Family A can access only specific types of information (e.g., specific images and blurbs), or no information. In one embodiment, the family member 511 may specify via the policy 424 that no users outside of Family A can determine that member 511 is associated with Family A (i.e., member 511 is “invisible” to users outside of Family A). Various other personal policy settings may be implemented to protect member 511's privacy.

Also as noted above with reference to FIG. 4, in addition to individual family member profiles and policies (e.g., family-based or personal profiles), each family itself has a family profile 412 and policy 414. The family profile 412 may include similar types of information as each individual member profile such as images related to the family, family blurbs and blogs, family interests, family contact information, and links for communicating with the family (e.g., via instant messaging and e-mail). In one embodiment, messages sent to the family may be sent to each individual member within the family. Thus, if a member of Family B sends an email to Family A, each member within Family A will receive the email. Alternatively (or in addition), if a member of Family A allows members from Family B to access the member's profile directly, then members from Family B can communicate directly with the member from Family A (rather than communicating with Family A as a group).

Family A's policy 414 specifies the types of information which may be accessed by each of the other Families or individual members who are “friends” of Family A and the types of information which may be accessed by each of the other Families or individual members (not otherwise in a family friend) who are not “friends” of Family A. For example, certain friends of Family A may be permitted to access all information within Family A's profile, whereas other families/members who are “friends” and/or families/members who are not friends may only be provided access to limited information from Family A's profile (e.g., basic blurbs and contact information). Various other security settings may be defined within the family profile 412 (within family policies 414) while still complying with the underlying principles of the embodiments described herein. For example, a particular family policy may exclude specific members of another family from accessing certain information within that particular family's profile. Also, an example family policy may limit (e.g., by age, gender, education level, criminal history, etc.) members of a family friend from being able to access specific information about the family, such as the member profiles of one or more of its family members or even being able to see a particular family member's inclusion within the family.

In one embodiment, the profile/policy of each individual family member takes precedence over the policy established by the family. For example, the family profile/policy may specify that other members of Family A and members of certain “friends” of Family A can access any information from any member profile. However, a particular family member 511 may limit the profile information made available to other users via the member's profile 422 (e.g., by specifying a limited set of members who can access the member's full profile in policy 424). Thus, in this embodiment, the “default” family policy 414 includes “full access” to all information but the member policy 424 overrides the default policy.

According to the techniques described herein, one (or more) particular member of each family may be assigned as the “administrator” of the family-based social network. As the administrator, the member is permitted to access and modify/manage the family profile 412 and the settings of the family policy 414. For instance, a first member to be associated with the family (that is, illustratively, the member who establishes/creates the family profile) may be by default the family administrator. Alternatively or in addition, a plurality of family administrators may be assigned to a family to manage the family profile and/or policy, such as by allowing all members to have administrative rights/access, or by allowing each administrator (or only an hierarchically highest administrator) to assign other family members as administrators. (In another embodiment, family members may vote on which member may be assigned as an administrator.)

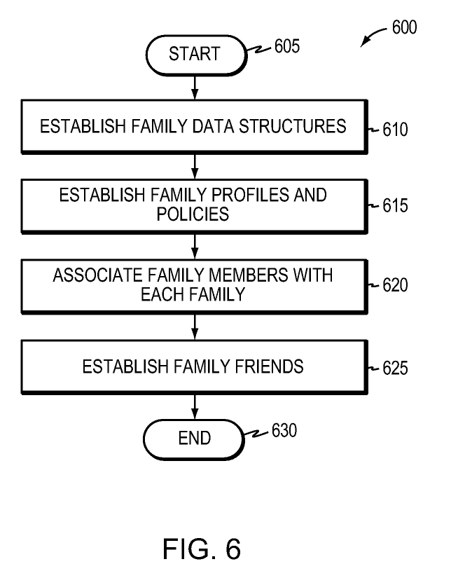

FIG. 6 illustrates an example simplified procedure 600 for establishment of social networking families in accordance with one or more embodiments described herein. Procedure 600 starts at step 605, and continues to step 610, where a plurality of social networking families (e.g., 410A-410N) are established by users through the social networking process/service 344 (e.g., through client web browsers 243 accessing the web server process 340 of server(s) 300). As noted above, each social networking family data structure 410 is illustratively stored in the profile/policy database 400 on server 300.

Family profiles 412 and family policies 414 may be established in step 615. Family profiles and policies may be established, e.g., by one or more family administrators or by one or more family members 420 (e.g., added below). In step 615, as mentioned above, a family profile is established to convey information about a family over the online social network, while a family policy is established to define (e.g., limit) access rights to information relating to a family.

In step 620, family members (e.g., for social networking users) are associated with each family 410, such as by establishing family member profiles 422 in data structures 420. The family members may be individuals with pre-existing social networking accounts (e.g., personal profiles 440/442) on the social networking service or may be new members to the social networking service. According to embodiments herein, family members of a particular family may be associated/established concurrently with the establishment of a family data structure and profile, or at a later time. As mentioned above, association of family members may be subject to one or more policies (e.g., personal policy, family member policy, family policy, etc.).

In step 625, family friends may be established or associated (linked) over the social network (list 430). This association may be implemented in a variety of ways. For example, each family may be identified within the database 400 of profiles and policies by, e.g., a unique family name or codeword. A family 410 may have any number of family friends 430 (or none at all). According to embodiments herein, family friends may be established in step 625 by, e.g., family policies, one or family administrators, family members, pairing families as friends based on common family characteristics, etc. The procedure 600 ends in step 630, notably with the ability to continue establishing/managing additional family data structures, family members, and family friends.

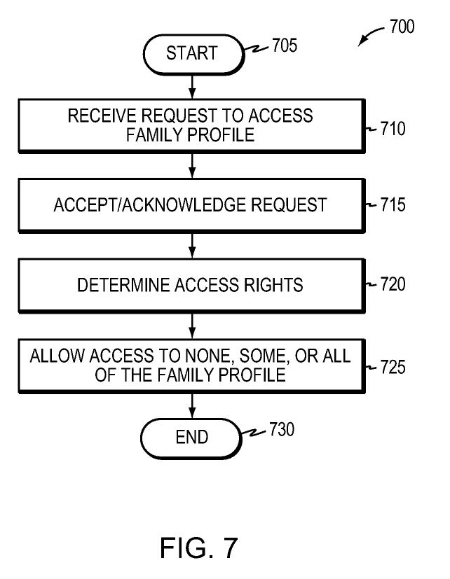

FIG. 7 illustrates an example simplified procedure 700 for management of access to a family profile in accordance with one or more embodiments described herein. Procedure 700 starts at step 705, and continues to step 710, where a request for either a family profile or an individual member profile is received at the social networking server 300. Illustratively, a family member (user) may attempt to access the profile of another family (e.g., a family to which the user does not belong), such as by accessing web server 348 from client web browser 243. In step 715, social networking process/services 344 interacts with social network protocol 346 to acknowledge an access request from a user (e.g., via web server 348). In step 720, social networking process 344 accesses profiles/policies database 400 to determine whether the user has access rights to the family profile 412. This determination may be performed, e.g., according to family friend associations and/or family policies. For example, if a user belongs to (is a member of) a family that is friends with the family having the family profile the user has requested to access, then the social networking process 344 may check (examine) family policies of one or both families (e.g., a family to which the user is a member or the family having the profile the user has requested to access). That is, as described above, family policies may define (e.g., limit) access rights to the family profile the user has requested.

If the user has access rights to a family profile (e.g., according to family friend associations or family policies), then the user is allowed to access the family profile in step 725 such as through generation of an appropriate web page by web server 348. For example, server 300 may generate a web page containing the profile information which is made available to friends according to family policy 414. The web page may be transmitted to a client device 200 (e.g., user) making the request and may be rendered on the web browser 243 executed on the client device.

Illustratively, the access allowed (granted) in step 725 may be limited by one or more policies (e.g., family policies). For example, a user may belong to a family that is friends with a family having a profile that the user has requested to access. In one embodiment described herein, a user may be allowed access to a complete (e.g., not limited) family profile. In another embodiment, a user may not be allowed to access any information in a family profile (e.g., completely restricted from access). In yet another embodiment, a user may be allowed to access some but not all of the information in a family profile (e.g., limited access). In this embodiment, the user will be allowed to access information of the family profile that is not restricted (e.g., by family friend associations or family policies) in step 725. According to embodiments herein, a user may be informed (e.g., by social networking process 344) of a limited or restricted family profile; that is, will be aware that certain information has been restricted. In other embodiments, a user may not know that some or all of the information of a family profile is not available to access by the user (e.g., a limited access profile appears to be complete to the user or a completed restricted profile appears not to exist to the user). The process 700 ends in step 730.

Advantageously, the embodiments described herein provide for family-based social networking. By allowing families (groups) to be friends with other families, the novel techniques efficiently allow a plurality of social networking groups to provide members with the benefits of being friends with other groups and their members without the need to become members of those other groups or to become friends with each member of those other groups. In particular, the additional functionality of family-based social networking described herein, such as policy hierarchies, family friends generally, and other features/functions, provide for a more versatile and robust social network experience for users/members.

While there have been shown and described illustrative embodiments that provide for family-based social networking, it is to be understood that various other adaptations and modifications may be made within the spirit and scope of the present invention. For example, the embodiments have been shown and described herein for use with certain applications, such as web browsers/servers, etc. However, the embodiments of the invention in their broader sense are not so limited, and may, in fact, be used with other applications, accordingly. For instance, in one or more embodiments web browser 243 may comprise a customized application, such a as a Java program code (e.g., Java applets), to implement the family-based social network, where client device 200 is configured to receive and transmit electronic messages for use with the customized application. Also, while the embodiments described above focus on a “social networking” environment, the underlying principles of the techniques herein are not necessarily limited to social networking. Moreover, while specific types of program code and communication media are described above, the embodiments of the invention are not limited to any particular type of communication protocol or communication media. For instance, in one embodiment, each of the components illustrated in FIGS. 4 and 5 may be implemented as objects within an object-oriented programming environment such as Java or C++. However, the underlying principles of the embodiments described herein may be implemented using any suitable type of program code, as may be appreciated by those skilled in the art.

Further, other types of policies, relationships, and associations may be realized through the advantageous techniques described herein. For example, a family policy may allow other members or families to locate the particular family profile by searching accessible information relating to the family (e.g., similar interests, location, etc.). Also, various family inter-relationships (associations) may be dynamically established, such as where common characteristics are found between families (e.g., through searching) dynamically associates the families as family friends, i.e., assuming such associations are allowed (or not disallowed) by the corresponding family policies. Moreover, transitive policies may be established, for example, where if Family A is friends with Family B, who is friends with Family C, then Family A and Family C may be friends (e.g., limited to a certain number of transitive associations, such that if Family D is friends with Family C, Family A and Family D are not necessarily friends).

In addition, as may be appreciated by those skilled in the art, and as briefly noted above, the use of the term “family” need not preclude “non-nuclear-families”, and as such, the term “family” may be interchanged with “group” herein. For example, businesses may be friends with other businesses, schools may be friends with other schools, etc.

The foregoing description has been directed to specific embodiments of this invention. It will be apparent, however, that other variations and modifications may be made to the described embodiments, with the attainment of some or all of their advantages. For instance, it is expressly contemplated that the components and/or elements described herein can be implemented as software embodied in a computer-readable medium (e.g., disks/CDs/etc.) having program instructions executing on a computer, hardware, firmware, or a combination thereof. Accordingly this description is to be taken only by way of example and not to otherwise limit the scope of the invention. Therefore, it is the object of the appended claims to cover all such variations and modifications as come within the true spirit and scope of the invention.

What is claimed is:

1. A method, comprising:
establishing social networking families in an online social network, each family having: (a) one or more family members; (b) a family profile comprising information related to the family; and (c) a family policy defining access rights to the information;
associating families as family friends within the social network; and
allowing, by the social network based on family policies and family friend associations, each family member of a first family to access a family profile of a second family provided that the first and second families are family friends.

2. The method as in claim 1, further comprising:
establishing a family member profile for one or more members of a particular family, each of the one or more family member profiles configured to provide information relating to a corresponding member of the particular family.

3. The method as in claim 2, further comprising:
allowing, by the social network based on the family policies and the family friend associations, access to the one or more family member profiles of the particular family.

4. The method as in claim 2, further comprising:
establishing a family member family policy for one or more of the family member profiles, each of the one or more family member policies to define access rights to a corresponding member profile of the particular family.

5. The method as in claim 4, further comprising:
allowing, by the social network based on the family policies and the family friend associations, access to the one or more family member profiles of the particular family.

6. The method as in claim 2, further comprising:
establishing a family member personal profile for one or more members of the particular family, each of the one or more family member personal profiles configured to provide information relating to a corresponding member of the particular family.

7. The method as in claim 6, further comprising:
allowing, by the social network based on the family policies and the family friend associations, access to the one or more family member personal profiles of the particular family.

8. The method as in claim 6, further comprising:
establishing a family member family personal policy for one or more of the family member personal profiles, each of the one or more family member personal policies to define access rights to a corresponding family member personal profile.

9. The method as in claim 8, further comprising:
allowing, by the social network based on the family member personal policies, family policies, and the family friend associations, access to the one or more family member personal profiles.

10. The method as in claim 6, further comprising:
establishing a family member family policy for one or more family member personal profiles, each of the one or more family member policies to define access rights to a corresponding family member personal profile; and
allowing, by the social network based on the family member policies and the family friend associations, access to the one or more family member personal profiles.

11. The method as in claim 1, further comprising:
assigning a family administrator to a family to manage at least one of either a family profile and a family policy.

12. The method as in claim 11, wherein the family policy is determined by the family administrator.

13. The method as in claim 11, wherein the family administrator is a first family member associated with the family.

14. The method as in claim 1, further comprising:
assigning a plurality of family administrators to a family, the plurality of family administrators to manage a family policy.

15. The method as in claim 1, wherein a family policy may exclude particular members of the second family from being accessible by the members of the first family.

16. The method as in claim 1, further comprising:
allowing, based on a particular family policy, other members or families to locate the particular family by searching accessible information relating to the family;
determining common characteristics between families; and
in response to determining common characteristics between families, associating the families as family friends.

17. An apparatus, comprising:
one or more network interfaces configured to communicate with clients connected over a network;
a processor coupled to the network interfaces and configured to execute a one or more processes; and
a memory configured to store a database defining a social network, the social network comprising: i) one or more family profiles comprising information related to a corresponding family; and ii) one or more a family policies defining access rights to the information; and
wherein the memory is further configured to store a social networking process executable by the processor, the social networking process when executed operable to: establish social networking families within the social network; associate families as family friends within the social network; and allowing, based on family policies and family friend associations of the social network, each family member of a first family to access a family profile of a second family provided that the first and second families are family friends.

18. The apparatus as in claim 17, wherein the database of the server further comprises family member profiles and family member policies.

19. The apparatus as in claim 17, wherein the database of the server further comprises family member personal profiles and family member personal policies.

20. An apparatus, comprising:
means for establishing social networking families in an online social network, each family having: (a) one or more family members; (b) a family profile comprising information related to the family; and (c) a family policy defining access rights to the information;
means for associating families as family friends within the social network; and
means for allowing, by the social network based on family policies and family friend associations, each family member of a first family to access a family profile of a second family provided that the first and second families are family friends.
